(19) United States
(12) Patent Application Publication
(10) Pub. No.: US 2014/0301309 A1
(43) Pub. Date: Oct. 9, 2014

(54) LOW COMPLEXITY BLIND DETECTION OF TRANSMISSION PARAMETERS OF INTERFERERS

(71) Applicant: QUALCOMM Incorporated, San Diego, CA (US)

(72) Inventors: Tao LUO, San Diego, CA (US); Arumugam CHENDAMARAI KANNAN, San Deigo, CA (US); Siddhartha MALLIK, San Diego, CA (US); Makesh Pravin JOHN WILSON, San Diego, CA (US); Taesang YOO, San Diego, CA (US); Yi HUANG, San Diego, CA (US)

(73) Assignee: QUALCOMM Incorporated, San Diego, CA (US)

(21) Appl. No.: 14/246,022

(22) Filed: Apr. 4, 2014

Related U.S. Application Data
(60) Provisional application No. 61/809,828, filed on Apr. 8, 2013.

(51) Int. Cl. H04W 24/02; H04L 5/00

(52) U.S. Cl. CPC H04W 24/02; H04L 5/0058
USPC 370/329

(57) ABSTRACT

A method, an apparatus, and a computer program product for wireless communication are provided. The apparatus reduces inference in a received signal. The apparatus receives a signal including transmissions from a plurality of cells. The apparatus determines transmission parameter hypotheses associated with the plurality of cells. Each transmission parameter hypothesis from the transmission parameter hypotheses includes a set of transmission parameters associated with all the cells from the plurality cells. The apparatus selects at least one transmission parameter hypothesis based on a first metric applied to each hypothesis. The apparatus refines transmission parameters associated with at least one cell from the plurality of cells. The refining includes improving an accuracy of the transmission parameters associated with the at least one cell based on a second metric associated with each cell individually.

### CROSS-REFERENCE TO RELATED APPLICATION(S)

This application claims the benefit of U.S. Provisional Application Ser. No. 61/809,828, entitled “LOW COMPLEXITY BLIND DETECTION OF TRANSMISSION PARAMETERS OF LTE INTERFERERS” and filed on Apr. 8, 2013, which is expressly incorporated by reference herein in its entirety.

### BACKGROUND

1. Field

The present disclosure relates generally to communication systems, and more particularly, to low complexity blind detection of transmission parameters of Long Term Evolution (LTE) interferers.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is LTE. LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus reduces inference in a received signal. The apparatus receives a signal, which includes transmissions from a plurality of cells. The apparatus determines transmission parameter hypotheses associated with the plurality of cells. Each transmission parameter hypothesis includes a set of transmission parameters associated with all the cells from the plurality cells. Furthermore, each transmission parameter hypothesis is associated with a first metric. The apparatus selects at least one transmission parameter hypothesis based on the first metric associated with each hypothesis. The apparatus then refines the transmission parameters associated with at least one cell from the plurality of cells based on at least one selected transmission parameter hypothesis. The apparatus refines the parameters by improving the accuracy of the transmission parameters associated with the at least one cell based on a second metric.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating a range expanded cellular region in a heterogeneous network.

FIG. 8 is a diagram for illustrating an exemplary method.

FIG. 9 is a flow chart of a method of reducing inference in a received signal.

FIG. 10 is a conceptual data flow diagram illustrating the data flow between different modules/means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

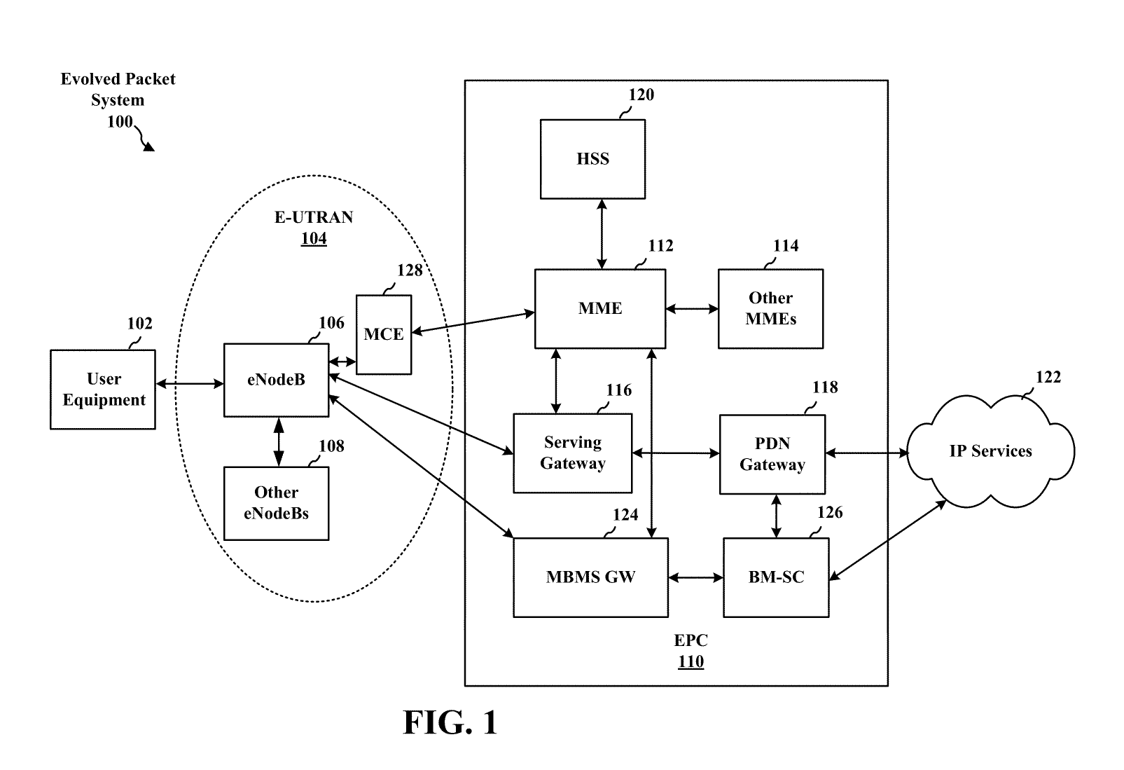

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

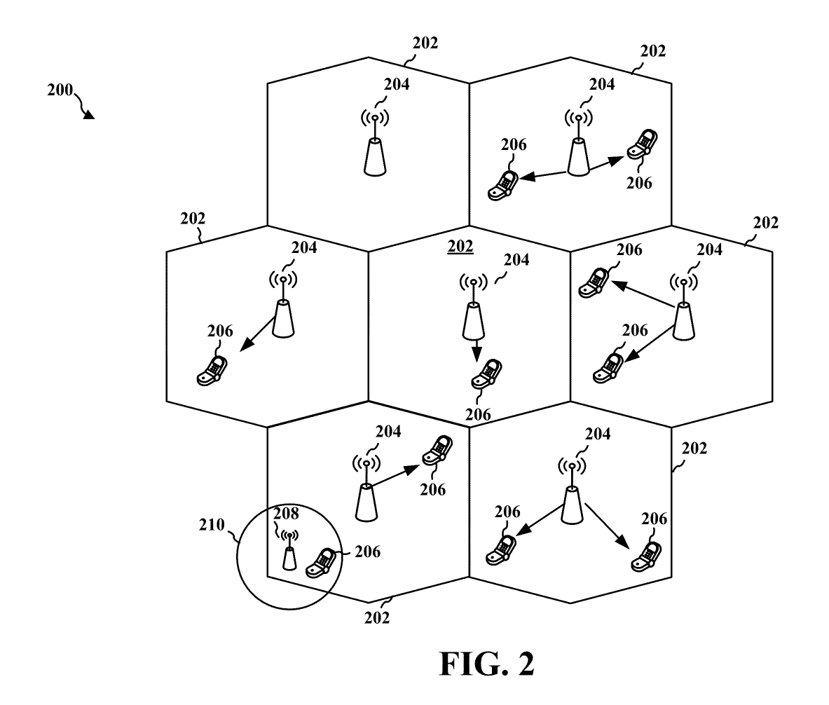

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

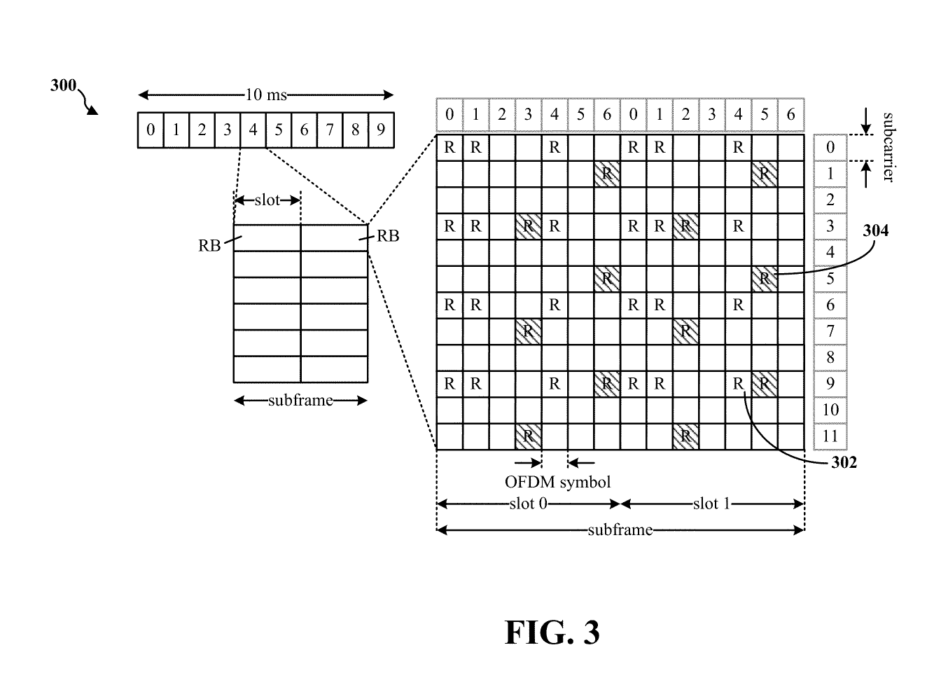

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

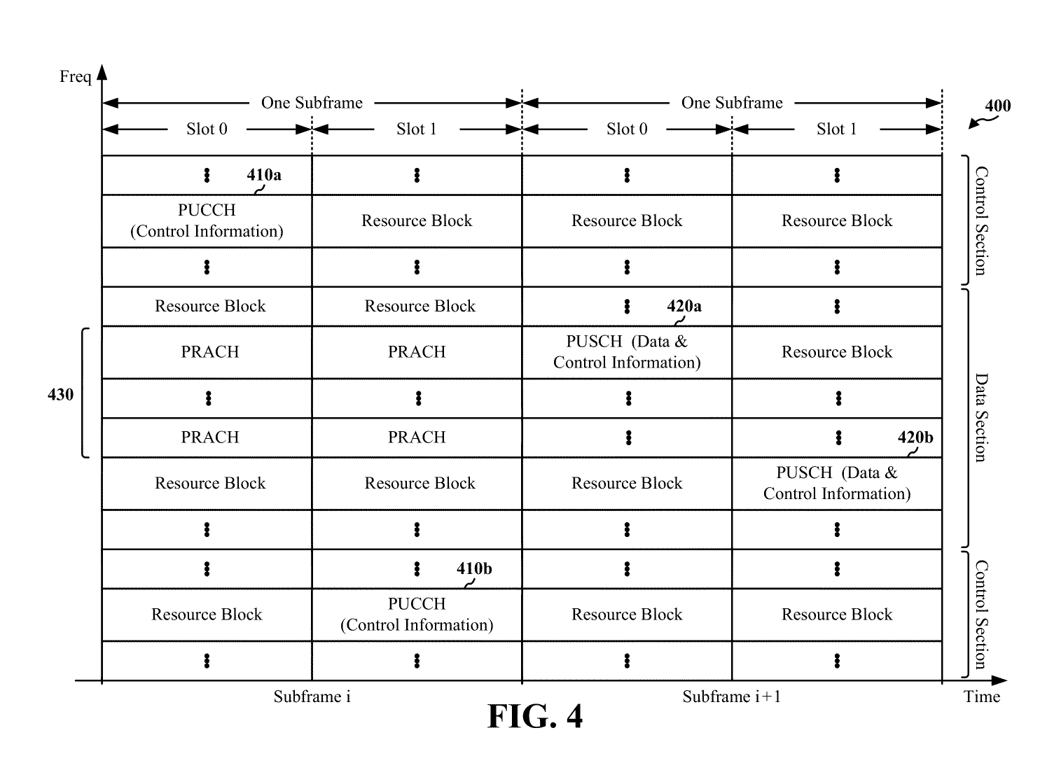

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

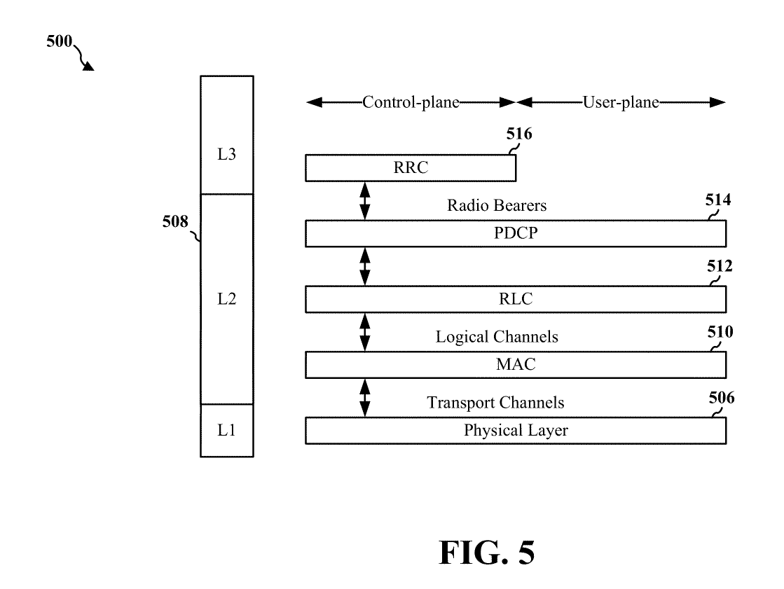

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

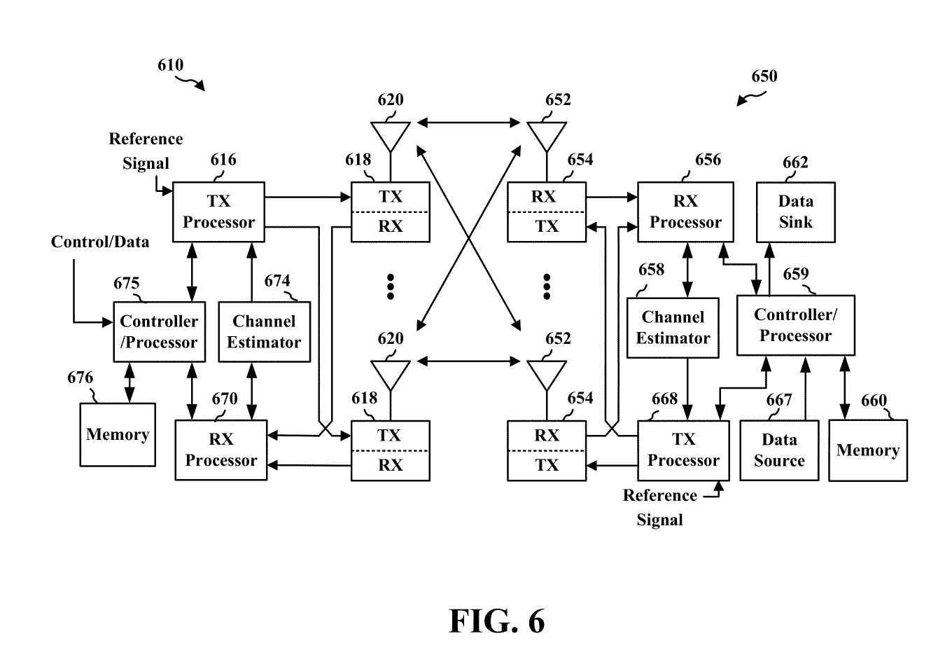

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

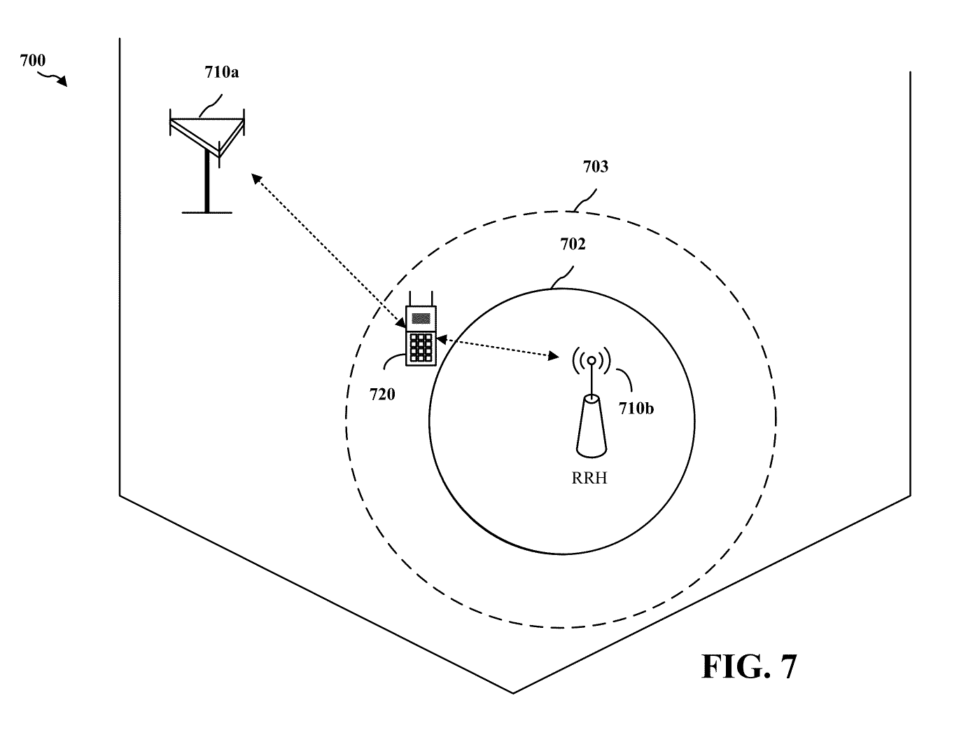

FIG. 7 is a diagram 700 illustrating a range expanded cellular region in a heterogeneous network. A lower power class eNB such as the RRH 710b may have a range expanded cellular region 703 that is expanded from the cellular region 702 through enhanced inter-cell interference coordination between the RRH 710b and the macro eNB 710a and through interference cancelation performed by the UE 720. In enhanced inter-cell interference coordination, the RRH 710b receives information from the macro eNB 710a regarding an interference condition of the UE 720. The information allows the RRH 710b to serve the UE 720 in the range expanded cellular region 703 and to accept a handoff of the UE 720 from the macro eNB 710a as the UE 720 enters the range expanded cellular region 703.

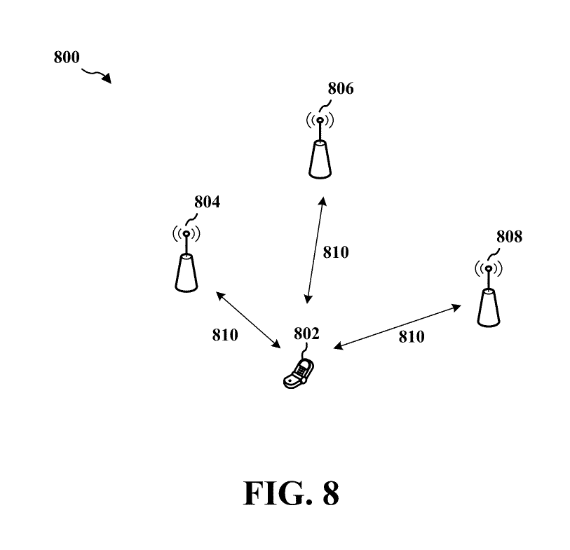

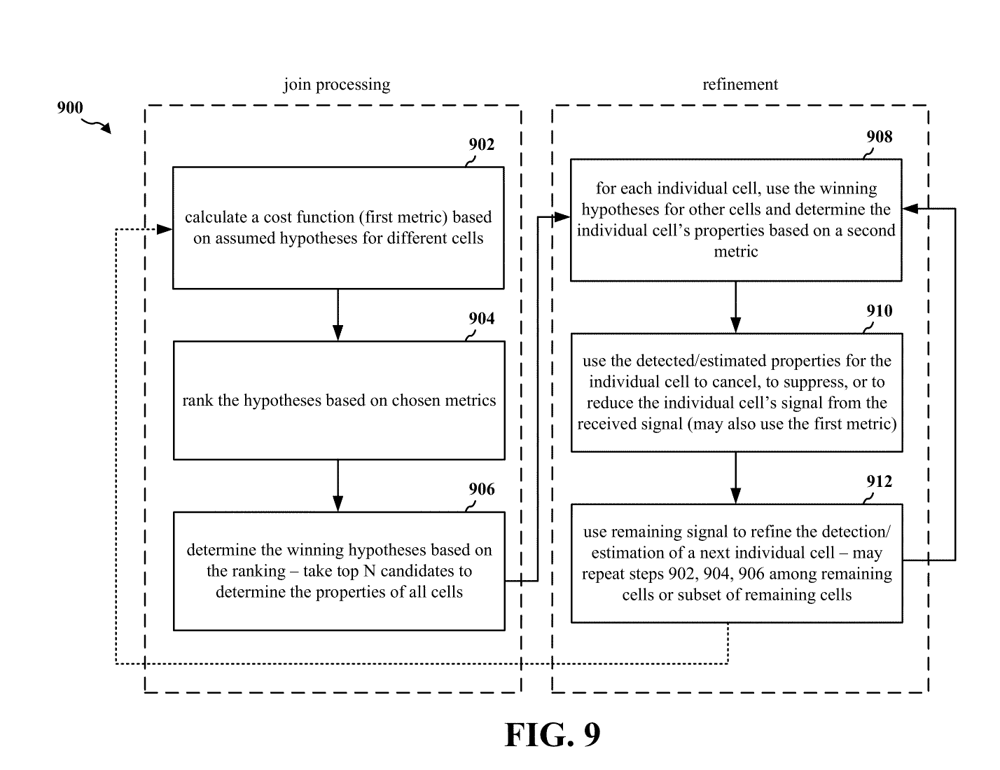

Reliability of serving cell decoding can be enhanced by interference handling at a UE. Interference handling includes interference suppression (IS) and interference cancelation (IC). If a UE is aware of transmission properties of an interfering cell, the UE can more effectively cancel, suppress, or otherwise reduce interference from the interfering cell. Transmission properties may include whether an interfering cell is transmitting, spatial schemes, a traffic to pilot ratio (TPR), a modulation order, and other transmission properties. Whether an interfering cell is transmitting may be true or false (on or off). Spatial schemes may include a CRS based transmission or a UE-RS based transmission. The CRS based transmission may be a space frequency block code (SFBC) transmission, a rank 1 transmission, a rank 2 transmission or a higher rank transmission, or another type of transmission. The UE-RS based transmission may be transmission rank information. The TPR may be one of several possible values (e.g., −5 dB, −3 dB, 0 dB, 3 dB, 5 dB). Whether an interfering cell is transmitting may be grouped into the TPR. As such, the TPR may include the value −∞ for when an interfering cell is not transmitting. The modulation order may be one of several possible values (e.g., BPSK, QPSK, M-QAM for various M). The transmission properties may differ for data and control channels. The granularity of a variation in interference properties may depend on several parameters such as a transmission mode, resource allocation type, etc. There is a need in both homogeneous and heterogeneous networks to reduce interference from one or more cells while receiving interference from multiple cells. Methods for reducing interference in a received signal are provided infra with respect to FIG. 8 and FIG. 9.

FIG. 8 is a diagram illustrating an exemplary method 800. In FIG. 8, a UE 802 receives a signal 810, which includes transmissions from cells 804, 806, 808. One cell may be a serving cell and the remaining cells may be interfering cells. For example, cell 804 may be a serving cell and cells 806, 808 may be interfering cells. The UE 802 efficiently detects/estimates transmission properties from the interfering cells 806, 808 by performing two steps: (1) a join-processing step, and (2) a refinement step.

In the join-processing step, the UE 802 determines transmission parameter hypotheses associated with cells 806, 808. Each transmission parameter hypothesis from the transmission parameter hypotheses includes a set of possible transmission parameters associated with cells 806, 808. The UE 802 determines a first probability metric to each hypothesis based on the confidence associated with each transmission parameter hypothesis. Thereafter, the UE selects at least one transmission parameter hypothesis, from the different transmission parameter hypotheses, based on the first probability metric associated with each hypothesis. Based on the implementation, the UE may select a single hypothesis having the highest first metric value, corresponding to a likely accurate hypothesis. Alternatively, the UE may select a plurality of the highest first metric value hypotheses.

For example, assume the UE 802 needs to determine the TPR and the spatial scheme for interfering cells 806, 808. The UE 802 may determine that there are three possible values of TPR for the cell 806 (e.g., TPR₁_{_{—}}_{eNB1}, TPR₂_{_{—}}_{eNB1}, TPR₃_{_{—}}_{eNB1}), two possible values of TPR for the cell 808 (e.g., TPR₁_{_{—}}_{eNB2}, TPR₂_{_{—}}_{eNB2}), and two possible values for the spatial scheme for each of the cells 806 (e.g., SS₁_{_{—}}_{eNB1}, SS₂_{_{—}}_{eNB1}), 808 (e.g., SS₁_{_{—}}_{eNB2}, SS₂_{_{—}}_{eNB2}). As such, there are 24 different combinations of transmission parameters for the cells 806, 808, corresponding to the total number of possible combinations of values for cells 806, 808 (3 TPR_{eNB1} values×2 TPR_{eNB2} values×2 SS_{eNB1} values×2 SS_{eNB2} values). The UE 802 applies a first probability metric to each hypothesis, each hypothesis being representable as {TPR_{eNB1}, TPR_{eNB2}, SS_{eNB1}, SS_{eNB2}}. Thereafter, the UE selects at least one transmission parameter hypothesis, of the 24 different transmission parameter hypotheses, based on a first probability metric associated with each hypothesis. Based on the implementation, the UE may select a single hypothesis having the highest first metric value, corresponding to a likely accurate hypothesis. Alternatively, the UE may select a plurality of the highest first metric value hypotheses.

For another example, assume the UE 802 needs to determine the TPR for interfering cells 806, 808. Assume also that the UE 802 determines that the interfering cell 806 may have four possible TPR values: 3 dB, 0 dB, −3 dB, and −∞ dB (or an extreme negative value, corresponding to no interference from the interfering cell 806 due to the interfering cell 806 not transmitting), and that the interfering cell 808 may have four possible TPR values: 6 dB, 0 dB, −6 dB, and −∞ dB (or an extreme negative value, corresponding to no interference from the interfering cell 806 due to the interfering cell 806 not transmitting). The UE 802 receives signal Y from the serving cell 804 and one or more of the interfering cells 806, 808. The received signal Y=f(TPR)S+f₁(TPR₁)I₁+f₂(TPR₂)I₂, where S is the received signal from the serving cell, I₁ is the received signal from the interfering cell 806, I₂ is the received signal from the interfering cell 808, TPR₁ may have one of four possible values, for example, 3 dB, 0 dB, −3 dB, and −∞ dB, and TPR₂ may have one of four possible values, for example, 6 dB, 0 dB, −6 dB, and −∞ dB. Accordingly, the UE 802 determines that there are 16 possible combinations of TPR for the interfering cells 806, 808. The UE 802 applies a first probability metric p₁ to each of the hypothesis to obtain a plurality of probabilities p_{1,i} for each i^{th} hypothesis of the 16 possible hypotheses:

| | | |
|---|---|---|
| I₁ - TPR | I₂ - TPR | Probability |

| | | | | |
|---|---|---|---|---|
| 3 | dB | 6 | dB | p_{1, 1} |
| 3 | dB | 0 | dB | p_{1, 2} |
| 3 | dB | −6 | dB | p_{1, 3} |
| 3 | dB | −∞ | dB | p_{1, 4} |
| 0 | dB | 6 | dB | p_{1, 5} |
| 0 | dB | 0 | dB | p_{1, 6} |
| 0 | dB | −6 | dB | p_{1, 7} |
| 0 | dB | −∞ | dB | p_{1, 8} |
| −3 | dB | 6 | dB | p_{1, 9} |
| −3 | dB | 0 | dB | p_{1, 10} |
| −3 | dB | −6 | dB | p_{1, 11} |
| −3 | dB | −∞ | dB | p_{1, 12} |
| −∞ | dB | 6 | dB | p_{1, 13} |
| −∞ | dB | 0 | dB | p_{1, 14} |
| −∞ | dB | −6 | dB | p_{1, 15} |
| −∞ | dB | −∞ | dB | p_{1, 16} |

The first probability metric p₁ may be a function of the received signal Y, TPR₁, and TPR₂. For example, the probability p_{1,1} may be determined based on the received signal Y and assumptions that TPR₁=3 dB and that TPR₂=6 dB. The first probability metric p₁ may be a function of additional parameters. Upon determining the probabilities p_{1,i} for each i^{th} hypothesis of the 16 possible hypotheses, the UE 802 may rank the hypotheses and select the hypothesis with the highest rank (i.e., highest probability p_{1,i}), or may select a set of hypotheses with the highest rank (e.g., probabilities p_{1,i} greater than a threshold T, or n hypothesis with the highest rank).

In the refinement step, the UE 802 refines transmission parameters associated with at least one cell of the cells 806, 808. The UE 802 may perform the refining step by improving an accuracy of the transmission parameters associated with the at least one cell based on a second probability metric. During the refinement step, the second probability metric is determined for each cell individually. This second metric may be the same or similar to the first metric, but is applied to individual cell analysis. Alternatively, the second metric may vary significantly from the first metric, being designed to evaluate the accuracy of individual cell parameters.

For example, assume that the UE 802 selects the hypothesis associated with the probabilities p_{1,3}, p_{1,4}, and p_{1,7} as being most likely. In the refinement step, the UE 802 may apply a second probability metric p₂ to determine whether the TPR for the interfering cell 806 is 3 dB or 0 dB. If based on the second metric, the UE 802 determines that the TPR for the interfering cell 806 is 3 dB. The UE 802 may then subtract (e.g., cancel or suppress) I₁ from the received signal Y based on an assumed TPR₁ of 3 dB to obtain a refined (interference subtracted or interference reduced) signal Y₂. When subtracting the signal I₁ from the received signal Y, the UE 802 may use the TPR₁ of 3 dB.

Subsequent to the refinement step, the UE may return to the join-processing step or further refine the other interferer values. In one configuration, the UE 802 performs join processing again with the signal Y₂ in order to estimate TPR₂ associated with the interfering cell 808. When performing join processing again, the UE 802 may determine a new set of possible values for TPR₂. Upon determining a set of likely hypotheses for TPR₂, the UE 802 may perform the refinement step again in order to determine a likely value for TPR₂ and to subtract I₂ from the received signal Y₂ based on the likely value for TPR₂ to generate a received signal Y₃, where Y₃ excludes signal hand signal I₂.

As discussed supra, the UE 802 estimates/detects transmission properties of the interfering cells 806, 808. If the UE 802 does not know the transmission parameters of the serving cell 804, the UE 802 may also estimate/detect the transmission properties of the serving cell 804. Accordingly, the UE 802 may perform the join-processing and refining steps on all of the cells 804, 806, 808, not just the interfering cells 806, 808.

FIG. 9 is a flow chart 900 of a method of reducing inference in a received signal. The method is performed by a UE, such as the UE 802.

In step 902, a UE calculates a cost function (i.e., a first probability metric) based on assumed hypotheses for different cells. The cost function may be a function of a received signal and the transmission properties of interfering cells. As discussed supra, the transmission properties may include a TPR, on/off transmission, a spatial scheme, a modulation order, and other transmission properties. The on/off transmission may be part of the TPR, assuming −∞ dB (or similar) is an off transmission and a value other than −∞ dB is an on transmission. A subset of the transmission properties can be chosen for each cell. A finite number of possible values are chosen for each transmission parameter in the subset. A different range of parameters values may be guessed/estimated for each cell. All or a subset of all possible hypotheses for each individual cell are taken into account. For example, in the case where the set of all possible hypotheses would be prohibitive, the UE may exclude highly unlikely hypothesis having improbable parameters.

In step 904, the UE ranks the hypotheses based on the cost function. However, this step may be skipped for implementations where the UE would pick the top candidate, or top N candidates, where N is a relatively small number or ranking or sorting is cost prohibitive.

In step 906, the UE determines the winning hypotheses based on the ranking in step 904, or similar method. In step 906, the UE may select the top N (N≧1) candidates to determine the properties for the cells.

In steps 908, 910, 912, the UE uses the results from step 906 to refine the detection/estimation for each individual cell. In step 908, for each individual cell, the UE uses the winning hypotheses for other cells and determines the individual cell's properties based on a second probability metric. The second probability metric and the first probability metric may be different or the same.

In step 910, the UE uses the detected/estimated properties for the individual cell to cancel, to suppress, or otherwise to reduce the individual cell's signal from the received signal. The UE may additionally use the first metric when performing step 910.

In step 912, the UE uses the remaining signal to refine the detection/estimation of a next individual cell. The UE may repeat steps 902, 904, 906 among remaining cells or a subset of remaining cells.

Accordingly, a UE may receive a signal including transmissions from a plurality of cells. The UE may determine transmission parameter hypotheses associated with the plurality of cells. Each transmission parameter hypothesis from the transmission parameter hypotheses may include a set of transmission parameters associated with all the cells from the plurality cells. The UE may select at least one transmission parameter hypothesis based on a first probability metric applied to each hypothesis. The UE may refine transmission parameters associated with at least one cell from the plurality of cells. The UE may refine by improving an accuracy of the transmission parameters associated with the at least one cell based on a second probability metric associated with each cell individually.

The UE may select the at least one transmission parameter hypothesis based on a ranking of transmission parameter hypotheses based on the first probability metric associated with each hypothesis. The UE may refine transmission parameters by subtracting a transmission associated with a cell from the received signal to obtain a refined signal. The subtracted transmission may be determined based on at least one of the first probability metric or the second probability metric. Each transmission parameter hypothesis may include cell-specific transmission parameters for each cell from the plurality of cells. The UE may refine transmission parameters by determining the second probability metric for each cell from the plurality of cells. In addition, the UE may subtract a transmission associated with a cell from the received signal to obtain a reduced received signal. The subtracted transmission may be determined based on a cell from the plurality of cells having a highest second probability metric. In addition, the UE may determine updated cell-specific transmission parameters for one or more cells based on the refined signal. Furthermore, the UE may determine an updated second probability metric for the one or more cells. The UE may repeat the steps of determining, selecting, and refining iteratively. Each subsequent repetition of the determining step may use the results of the previous refining step.

The transmission parameters may include at least one of a modulation order, a TPR, a spatial scheme, or whether there is an interfering transmission. The spatial scheme may include one a CRS based transmission or a UE-RS based transmission. The CRS based transmission may include one of an SFBC transmission, a rank 1 transmission, a rank 2 transmission, or a higher rank transmission. The UE-RS based transmission may be transmission rank information. The UE may determine the transmission parameter hypotheses for the plurality of cells by determining a transmission parameter hypothesis for each of the plurality of cells, determining the first probability metric for each transmission parameter hypothesis, and ranking the plurality of transmission parameter hypotheses based on the first probability metric associated with each transmission parameter hypothesis.

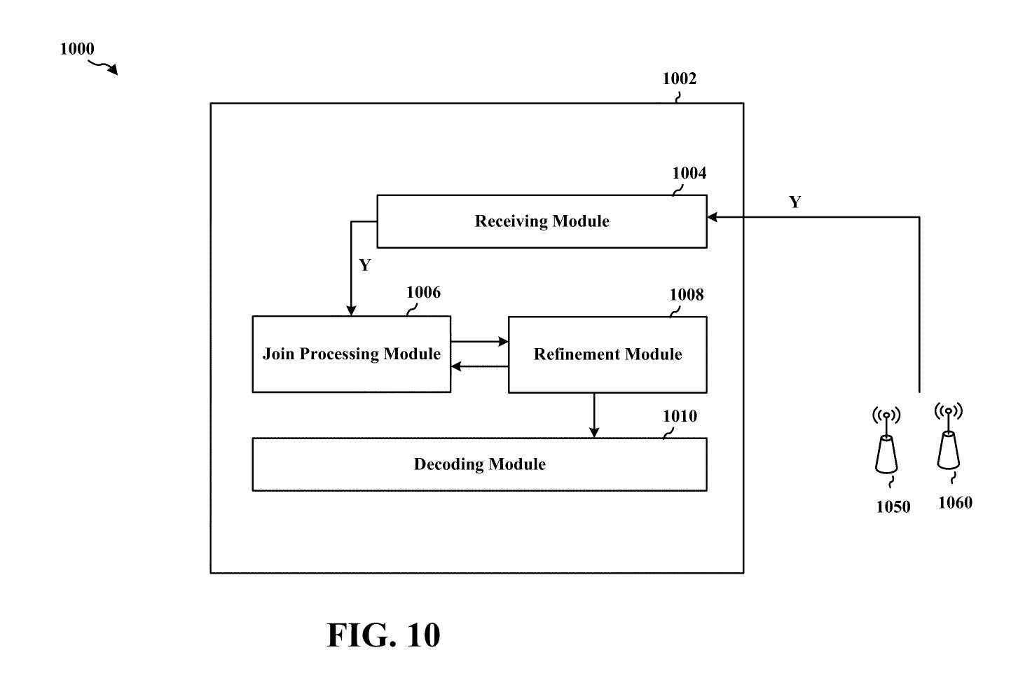

FIG. 10 is a conceptual data flow diagram 1000 illustrating the data flow between different modules/means/components in an exemplary apparatus 1002. The apparatus may be a UE. The apparatus includes a receiving module 1004 that is configured to receive a signal Y including transmissions from a plurality of cells 1050, 1060. The plurality of cells including a serving cell 1050 and one or more interfering cells 1060. The apparatus further includes a join processing module 1006 that is configured to determine transmission parameter hypotheses associated with the plurality of cells. Each transmission parameter hypothesis from the transmission parameter hypotheses includes a set of transmission parameters associated with all the cells from the plurality cells. The join processing module 1006 is further configured to select at least one transmission parameter hypothesis based on a first probability metric applied to each hypothesis. The apparatus further includes a refinement module 1008 that is configured to refine transmission parameters associated with at least one cell from the plurality of cells. The refinement module 1008 is configured to refine by improving an accuracy of the transmission parameters associated with the at least one cell based on a second probability metric associated with each cell individually.

The join processing module 1006 may be configured to select based on a ranking of transmission parameter hypotheses based on the first probability metric associated with each hypothesis. The refinement module 1008 may be configured to refine by subtracting a transmission associated with a cell from the received signal to obtain a refined signal. The subtracted transmission may be determined based on at least one of the first probability metric or the second probability metric. In one configuration, each transmission parameter hypothesis includes cell-specific transmission parameters for each cell from the plurality of cells, and the refinement module 1008 is configured to refine by determining the second probability metric for each cell from the plurality of cells; subtracting a transmission associated with a cell from the received signal to obtain a reduced received signal, the subtracted transmission being determined based on a cell from the plurality of cells having a highest second probability metric; determining updated cell-specific transmission parameters for one or more cells based on the refined signal; and determining an updated second probability metric for the one or more cells. The apparatus may repeat the steps of determining, selecting, and refining iteratively. Each subsequent repetition of the determining step may use the results of the previous refining step.

The transmission parameters may include at least one of a modulation order, a TPR, a spatial scheme, or whether there is an interfering transmission. The spatial scheme may be one of a CRS based transmission or a UE-RS based transmission. The CRS based transmission may be one of an SFBC transmission, a rank 1 transmission, a rank 2 transmission, or a higher rank transmission. The UE-RS based transmission may be transmission rank information. The join processing module 1006 may be configured to determine the transmission parameter hypotheses for the plurality of cells by determining a transmission parameter hypothesis for each of the plurality of cells, determining the first probability metric for each transmission parameter hypothesis, and ranking the plurality of transmission parameter hypotheses based on the first probability metric associated with each transmission parameter hypothesis. The join processing module 1006 may determine the transmission parameter hypotheses for the transmission parameters for each of the plurality cells by determining a set of hypotheses. The set of hypotheses may include a hypothesis for each combination of possible values for n transmission parameters.

The apparatus may include additional modules that perform each of the steps of the algorithm in the aforementioned flow chart of FIG. 9. As such, each step in the aforementioned flow chart of FIG. 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

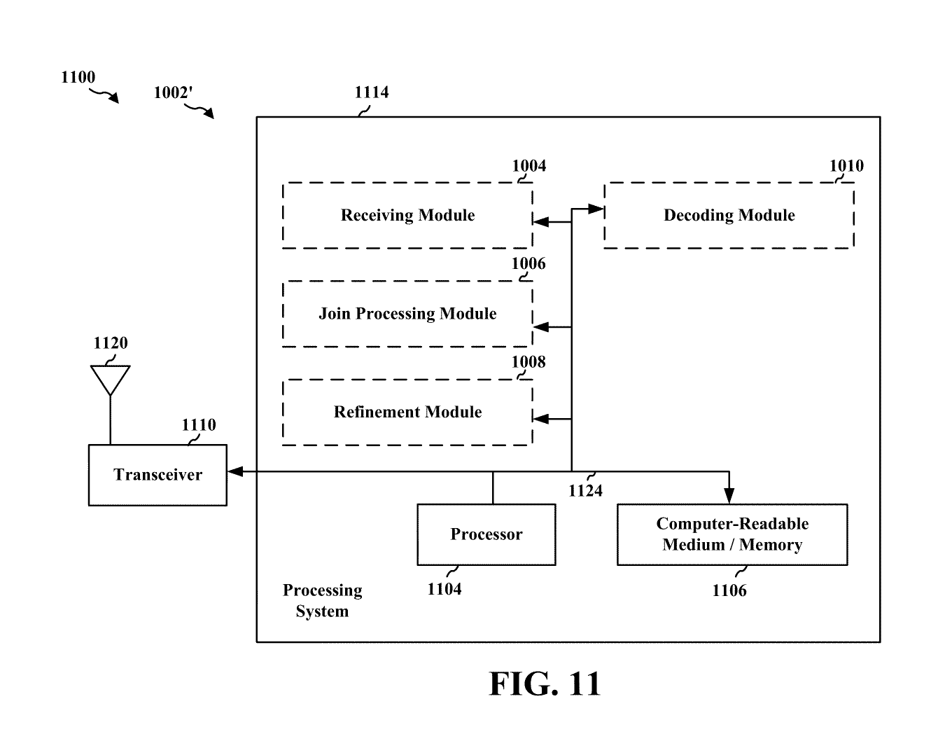

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1104, the modules 1004, 1006, 1008, 1010 and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114. In addition, the transceiver 1110 receives information from the processing system 1114, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system further includes at least one of the modules 1004, 1006, 1008, and 1010. The modules may be software modules running in the processor 1104, resident/stored in the computer readable medium/memory 1106, one or more hardware modules coupled to the processor 1104, or some combination thereof. The processing system 1114 may be a component of the UE 650 and may include the memory 660 and/or at least one of the TX processor 668, the RX processor 656, and the controller/processor 659.

In one configuration, the apparatus 1002/1002′ for wireless communication reduces interference in a received signal. The apparatus includes means for receiving a signal including transmissions from a plurality of cells. The apparatus further includes means for determining transmission parameter hypotheses associated with the plurality of cells. Each transmission parameter hypothesis from the transmission parameter hypotheses includes a set of transmission parameters associated with all the cells from the plurality cells. The apparatus further includes means for selecting at least one transmission parameter hypothesis based on a first probability metric applied to each hypothesis. The apparatus further includes means for refining transmission parameters associated with at least one cell from the plurality of cells. The refining includes improving an accuracy of the transmission parameters associated with the at least one cell based on a second probability metric associated with each cell individually.

In one configuration, the means for selecting performs the selecting based on a ranking of transmission parameter hypotheses based on the first probability metric associated with each hypothesis. In one configuration, the means for refining is configured to refine by subtracting a transmission associated with a cell from the received signal to obtain a refined signal. The subtracted transmission may be determined based on at least one of the first probability metric or the second probability metric. In one configuration, each transmission parameter hypothesis includes cell-specific transmission parameters for each cell from the plurality of cells, and the means for refining is configured to determine the second probability metric for each cell from the plurality of cells; subtract a transmission associated with a cell from the received signal to obtain a reduced received signal, the subtracted transmission being determined based on a cell from the plurality of cells having a highest second probability metric; determine updated cell-specific transmission parameters for one or more cells based on the refined signal; and determine an updated second probability metric for the one or more cells. In one configuration, the apparatus further includes means for repeating the steps of determining, selecting, and refining iteratively. In such a configuration, each subsequent repetition of the determining step uses the results of the previous refining step. In one configuration, the means for determining the transmission parameter hypotheses for the plurality of cells is configured to determine a transmission parameter hypothesis for each of the plurality of cells, to determine the first probability metric for each transmission parameter hypothesis, and to rank the plurality of transmission parameter hypotheses based on the first probability metric associated with each transmission parameter hypothesis. The means for determining the transmission parameter hypotheses for the transmission parameters for each of the plurality cells may be configured to determine a set of hypotheses. The set of hypotheses may include a hypothesis for each combination of possible values for n transmission parameters.

The aforementioned means may be one or more of the aforementioned modules of the apparatus 1002 and/or the processing system 1114 of the apparatus 1002′ configured to perform the functions recited by the aforementioned means. As described supra, the processing system 1114 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of reducing inference in a received signal, comprising:
receiving a signal including transmissions from a plurality of cells;
determining transmission parameter hypotheses associated with the plurality of cells, each transmission parameter hypothesis from the transmission parameter hypotheses including a set of transmission parameters associated with all the cells from the plurality cells;
selecting at least one transmission parameter hypothesis based on a first metric applied to each hypothesis; and
refining transmission parameters associated with at least one cell from the plurality of cells, the refining including improving an accuracy of the transmission parameters associated with the at least one cell based on a second metric associated with each cell individually.

2. The method of claim 1, wherein the selecting is based on a ranking of transmission parameter hypotheses based on the first metric associated with each hypothesis.

3. The method of claim 1, wherein the refining further comprises subtracting a transmission associated with a cell from the received signal to obtain a refined signal, the subtracted transmission being determined based on at least one of the first metric or the second metric.

4. The method of claim 1, wherein each transmission parameter hypothesis includes cell-specific transmission parameters for each cell from the plurality of cells, and the refining further comprises:
determining the second metric for each cell from the plurality of cells;
subtracting a transmission associated with a cell from the received signal to obtain a reduced received signal, the subtracted transmission being determined based on a cell from the plurality of cells having a highest second metric;
determining updated cell-specific transmission parameters for one or more cells based on the refined signal; and
determining an updated second metric for the one or more cells.

5. The method of claim 1, further comprising repeating the steps of determining, selecting, and refining iteratively, wherein each subsequent repetition of the determining uses the results of the previous refining step.

6. The method of claim 1, wherein the transmission parameters comprise at least one of a modulation order, a traffic to pilot ratio (TPR), a spatial scheme, or whether there is an interfering transmission.

7. The method of claim 6, wherein the spatial scheme comprises one of a cell-specific reference signal (CRS) based transmission or a user equipment (UE) specific reference signal (UE-RS) based transmission.

8. The method of claim 7, wherein the CRS based transmission comprises one of a space frequency block code (SFBC) transmission, a rank 1 transmission, a rank 2 transmission, or a higher rank transmission.

9. The method of claim 7, wherein the UE-RS based transmission comprises transmission rank information.

10. The method of claim 1, wherein the determining the transmission parameter hypotheses for the plurality of cells comprises:
determining a transmission parameter hypothesis for each of the plurality of cells;
determining the first metric for each transmission parameter hypothesis; and
ranking the plurality of transmission parameter hypotheses based on the first metric associated with each transmission parameter hypothesis.

11. The method of claim 10, wherein the determining the transmission parameter hypotheses for the transmission parameters for each of the plurality cells comprises determining a set of hypotheses, the set of hypotheses including a hypothesis for each combination of possible values for n transmission parameters.

12. An apparatus for reducing inference in a received signal, comprising:
means for receiving a signal including transmissions from a plurality of cells;
means for determining transmission parameter hypotheses associated with the plurality of cells, each transmission parameter hypothesis from the transmission parameter hypotheses including a set of transmission parameters associated with all the cells from the plurality cells;
means for selecting at least one transmission parameter hypothesis based on a first metric applied to each hypothesis; and
means for refining transmission parameters associated with at least one cell from the plurality of cells, the refining including improving an accuracy of the transmission parameters associated with the at least one cell based on a second metric associated with each cell individually.

13. The apparatus of claim 12, wherein the means for selecting is configured to select the at least one transmission parameter hypothesis based on a ranking of transmission parameter hypotheses based on the first metric associated with each hypothesis.

14. The apparatus of claim 12, wherein the means for refining is configured to subtract a transmission associated with a cell from the received signal to obtain a refined signal, the subtracted transmission being determined based on at least one of the first metric or the second metric.

15. The apparatus of claim 12, wherein each transmission parameter hypothesis includes cell-specific transmission parameters for each cell from the plurality of cells, and the means for refining is configured to:
determine the second metric for each cell from the plurality of cells;
subtract a transmission associated with a cell from the received signal to obtain a reduced received signal, the subtracted transmission being determined based on a cell from the plurality of cells having a highest second metric;
determine updated cell-specific transmission parameters for one or more cells based on the refined signal; and
determine an updated second metric for the one or more cells.

16. The apparatus of claim 12, further comprising means for repeating the steps of determining, selecting, and refining iteratively, wherein each subsequent repetition of the determining uses the results of the previous refining step.

17. The apparatus of claim 12, wherein the transmission parameters comprise at least one of a modulation order, a traffic to pilot ratio (TPR), a spatial scheme, or whether there is an interfering transmission.

18. The apparatus of claim 17, wherein the spatial scheme comprises one of a cell-specific reference signal (CRS) based transmission or a user equipment (UE) specific reference signal (UE-RS) based transmission.

19. The apparatus of claim 18, wherein the CRS based transmission comprises one of a space frequency block code (SFBC) transmission, a rank 1 transmission, a rank 2 transmission, or a higher rank transmission.

20. The apparatus of claim 18, wherein the UE-RS based transmission comprises transmission rank information.

21. The apparatus of claim 12, wherein the means for determining the transmission parameter hypotheses for the plurality of cells is configured to:
determine a transmission parameter hypothesis for each of the plurality of cells;
determine the first metric for each transmission parameter hypothesis; and
rank the plurality of transmission parameter hypotheses based on the first metric associated with each transmission parameter hypothesis.

22. The apparatus of claim 21, wherein the means for determining the transmission parameter hypotheses for the transmission parameters for each of the plurality cells is configured to determine a set of hypotheses, the set of hypotheses including a hypothesis for each combination of possible values for n transmission parameters.

23. An apparatus for reducing inference in a received signal, comprising:
a memory; and
at least one processor coupled to the memory and configured to:
receive a signal including transmissions from a plurality of cells;
determine transmission parameter hypotheses associated with the plurality of cells, each transmission parameter hypothesis from the transmission parameter hypotheses including a set of transmission parameters associated with all the cells from the plurality cells;
select at least one transmission parameter hypothesis based on a first metric applied to each hypothesis; and
refine transmission parameters associated with at least one cell from the plurality of cells by improving an accuracy of the transmission parameters associated with the at least one cell based on a second metric associated with each cell individually.

24. The apparatus of claim 23, wherein the at least one processor is configured to select the at least one transmission parameter hypothesis based on a ranking of transmission parameter hypotheses based on the first metric associated with each hypothesis.

25. The apparatus of claim 23, wherein the at least one processor is configured to refine the transmission parameters by subtracting a transmission associated with a cell from the received signal to obtain a refined signal, the subtracted transmission being determined based on at least one of the first metric or the second metric.

26. The apparatus of claim 23, wherein each transmission parameter hypothesis includes cell-specific transmission parameters for each cell from the plurality of cells, and the at least one processor is configured to refine the transmission parameters by:
determining the second metric for each cell from the plurality of cells;
subtracting a transmission associated with a cell from the received signal to obtain a reduced received signal, the subtracted transmission being determined based on a cell from the plurality of cells having a highest second metric;
determining updated cell-specific transmission parameters for one or more cells based on the refined signal; and
determining an updated second metric for the one or more cells.

27. The apparatus of claim 23, wherein the at least one processor is further configured to repeat the steps of determining, selecting, and refining iteratively, wherein each subsequent repetition of the determining uses the results of the previous refining step.

28. The apparatus of claim 23, wherein the transmission parameters comprise at least one of a modulation order, a traffic to pilot ratio (TPR), a spatial scheme, or whether there is an interfering transmission.

29. The apparatus of claim 23, wherein the at least one processor is configured to determine the transmission parameter hypotheses for the plurality of cells by:
determining a transmission parameter hypothesis for each of the plurality of cells;
determining the first metric for each transmission parameter hypothesis; and
ranking the plurality of transmission parameter hypotheses based on the first metric associated with each transmission parameter hypothesis.

30. A computer program product for reducing inference in a received signal, comprising:
a computer-readable medium comprising code for:
receiving a signal including transmissions from a plurality of cells;
determining transmission parameter hypotheses associated with the plurality of cells, each transmission parameter hypothesis from the transmission parameter hypotheses including a set of transmission parameters associated with all the cells from the plurality cells;
selecting at least one transmission parameter hypothesis based on a first metric applied to each hypothesis; and
refining transmission parameters associated with at least one cell from the plurality of cells, the refining including improving an accuracy of the transmission parameters associated with the at least one cell based on a second metric associated with each cell individually.
